(19) United States
(12) Patent Application Publication
(10) Pub. No.: US 2018/0223562 A1
(43) Pub. Date: Aug. 9, 2018

(54) PORTABLE POST PULLER DEVICE

(71) Applicant: HARRY ROSARIO, FORT WORTH, TX (US)

(72) Inventor: HARRY ROSARIO, FORT WORTH, TX (US)

(21) Appl. No.: 15/426,280

(22) Filed: Feb. 7, 2017

(51) Int. Cl. E04H 17/26; B66F 1/02

(52) U.S. Cl. CPC E04H 17/265; B66F 1/02

(57) ABSTRACT

A device for pulling a post from the ground with a minimum effort includes a removable and movable tower base footing plate. The device comprises a vertical jack tower, removable jack, and diametrically adjustable member connected to the tower base footing plate for securely gripping a post circumferentially. The support plates attached to the tower base footing plate provides back support for mechanically pulling the post from the ground.

### BACKGROUND

### 1. Field of the Invention

The present invention relates to devices used in cooperation with a jack to remove the post which are embedded in the ground. Posts are used for many applications, but may be for purposes herein can be of the type to support a fence. Overtime, it is at many times necessary to remove them from the ground.

While the prior devices for removing post are considered to be useful, often they are inconvenient to use, expensive to manufacture, and in some instances even dangerous to the individual using them. Accordingly, there exists a need for an improved post puller, that is easy to transport, effective, simple to use and is safe.

### 2. Description of Prior Art

Posts are commonly made of metal or wood, but may be of plastic or other material. A concrete footing is commonly employed to secure the post in the ground. Many times such posts are required to be removed. The removal of such post can be quite difficult.

Unsuccessful removal of a post by hand can result in a broken portion of the post and footing remaining secured in the ground. This necessitates digging around the footing to remove the concrete and attached post portion.

Further, posts come in a variety of cross-sectional shapes and diameters. The cross-section may be round or rectangular shaped, for example. Accordingly, prior post pulling tools are designed to remove a particular cross sectional shape.

Further, prior post pullers typically must be placed over the top of the post or post and brought down to the proper position before removal. This requires the user to remove nails or other obstructions before the device can be used. Such a requirement increases the overall time and work required.

Accordingly, there is a need for a device which can quickly remove a post with minimal effort. Further, there is a need for a post puller that can remove posts of varying cross-sectional sizes and shapes. There also remains a need for a post puller which can remove post with an attached concrete footing thereto.

While the above described devices have similarities with the present invention, they differ in material respects. These differences reveal advantages over the prior devices.

### SUMMARY OF THE INVENTION

The present invention relates to a portable post puller device which applies substantially lineal force to pull a post from the ground by operating the jack vertically.

In view of the current disadvantages inherent in the known post puller arts, the present invention provides a novel jack tower, removable jack, and post gripper. The general purpose of the present invention is to provide ease and convenience of use and portability of the post puller device. According to the prior art, prior post puller devices require that the operator complete the operation in a forward leaning position to get proper balance of the unit and proper leverage when extracting the post, resulting in back strain and related back injuries. Many puller devices apply a load from the side of the post or utilize a pulling force with a large lateral component relative to the axis of the post, making the post difficult to extract. However, the present invention allows for a portable, safe, and flexible post puller which applies a pulling force primarily along the axis of the post.

In a preferred embodiment, the present invention has a jack tower including a pair of parallel columns, a tower bridge, and a tower bridge jack receiver. The tower bridge jack receiver being on the top of the tower prevents the jack bar from being bent by jack arm's force. The present invention also provides a post puller capable of exerting a pulling force directly on the axis of the post.

In another preferred embodiment, a jack noze is attachable and detachable from the head of the jack runner to assist in setting and keeping the post at a vertical coextending distance from the unit generally parallel to the shaft. The jack noze also prevents the top of the post from contacting the jack bar during the withdrawal of the post from the ground and from having a pinch hand when extracting and transporting the post.

Another preferred embodiment of the invention is to provide a portable post puller device with a cross member which may pivotably secured on the jack bar in order to loosen the jack from the jack tower.

In another preferred embodiment of the invention, the post gripper includes a tong jaws but not limited to a self-tightening clamp gripper, a clamp tightened on the stake, or post using fasteners. The present invention provides a post gripper that is able to removably grip a partially buried post for extracting from hard packed soil or concretes. Those with ordinary skill in the art will now appreciate that by understanding the art of self-tightening clamp grippers as described herein, methods of use will be understood by those knowledgeable in such art.

The jack tower assembly is preferably made from steel or any other metal alloy. A pair of wheels may be mounted to the tower base footing plate for portability permitting the post puller to be easily transported by hand, without the need for a vehicle to transport the puller.

The present invention holds significant improvements and serves as a post puller system. For purposes of summarizing the invention, certain aspects, advantages, and novel features of the invention have been described herein. It is to be understood that not necessarily all such advantages may be achieved in accordance with anyone particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference the following drawings and detailed description.

Further objects and advantages of the present invention will become apparent from a description of the several embodiments as set forth in the following description and drawings.

### BRIEF DESCRIPTION OF DRAWINGS

FIG. 1 is perspective view of the portable post puller device according to a preferred embodiment of the present invention.

FIG. 2 is a side view of the device.

FIG. 3 is a front view of the device according to a preferred embodiment of the present invention.

### DETAILED DESCRIPTION OF THE INVENTION

The following description includes the best mode presently contemplated for carrying out the invention. This description is not to be taken in a limiting sense, but is made merely for the purpose of describing the general principles of the invention. The scope of the invention should be determined with reference to the claims.

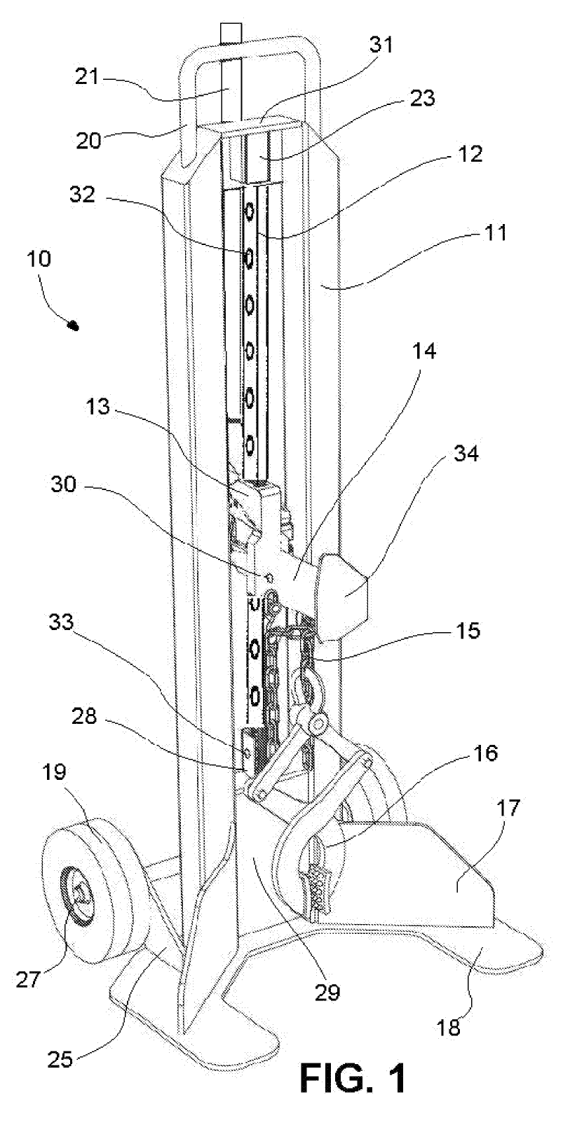

Referred to FIG. 1, the portable post puller device includes a tower base footing plate footing plate 18 made of steel, or can be of any suitable rigid material. The tower base footing plate footing plate 18 is generally in V-shape having a pair of opposing arms.

A pair of support plates 17 which serve as retaining support members for the post, which can also be steel, extend generally perpendicular to the tower base footing plate 18 and diagonally outward as seen in FIG. 1, which aid the transportation of the post.

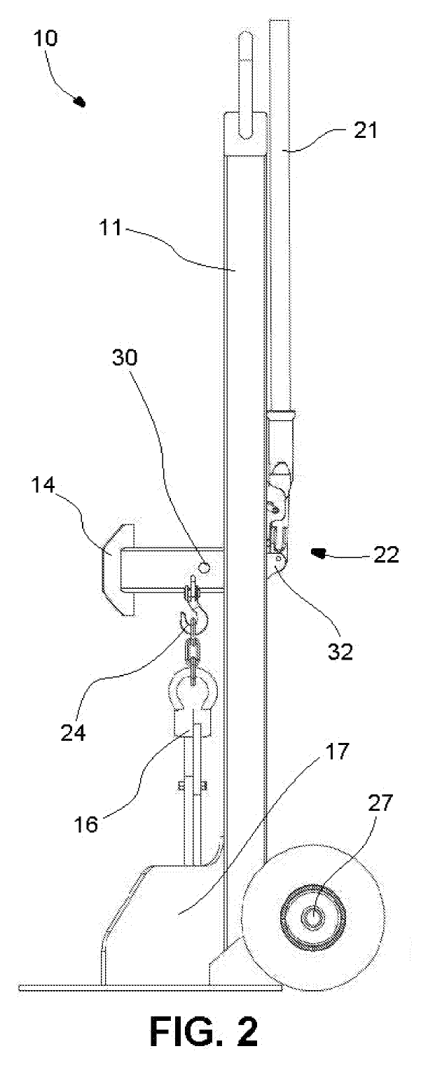

Still in FIGS. 1-2, the support plates 17 are fixed to the tower base footing plate 18 by welding. A pair of axle frame support members 25 can also be of steel and welded to tower base footing plate 18.

FIG. 1 shows a foot axle crossbar 26 extends through the precision ball bearing 27 as shown in FIGS. 1-2. Wheels 19 are attached to the foot axle crossbar 26. A vertical jack bar 12, which can be steel, is removably connected to a tower lower jack receiver 28 welded on a spine support plate 29 and a tower bridge jack receiver 23 welded on a tower bridge jack receiver member 31. The vertical jack bar 12 can be steel tubing and of a predetermined height. A jack sleeve 13 is connected, via welding for example, to the vertical member 34.

The V-shaped tower base footing plate 18 is a size such that the opening defined between the arms typically is large enough to enable the post with an associated predetermined amount of concrete to be pulled out of the ground without having to disjoin the same. Once positioned, the tong jaw 16 grips the post and the jack is then operated to cause the jack sleeve 13 in turn the post to be vertically displaced from its planted position.

As shown in FIGS. 1-3, an elongated vertical jack bar 12 extends from the sleeve 28 and serves as a track for a jack head 22. The tower lower jack receiver 28 is generally U-shaped (FIG. 1) so the jack can be removed from the jack tower 11. When the jack bar 12 is seated in the tower lower jack receiver 28, a securing pin 33 extends through a bore of the tower lower jack receiver 28 and one of the lower spaced surfaces 32 to secure the jack bar 12 to the tower lower jack receiver 28. The jack bar 12 includes a plurality of incrementally spaced surfaces 32 which terminate adjacent the tower bridge jack receiver 23.

Referred to FIGS. 1-2, the head 22 includes a jack runner 13, which slidably receives the jack bar 12 there through. The securing pin 33 pivotally connects to the jack bar 12 to enable secure selective positioning of the jack runner 13 along the jack bar 12. A jack arm 21 is attached to the jack runner 13 and is provided as an additional leverage tool to achieve greater raising force with minimal exertion.

Still FIGS. 1-2, a jack noze 14 is attached to the jack runner 13 secured by a jack noze securing pin 30 to allow the jack noze 14 to be removed from the jack runner 13. A chain 15 removably connects to the jack noze 14 by a clevis hook 24, as displayed in FIG. 2. A portion of the chain 15 is connected to an opening of the tong jaw 16. Another end of the chain 15 is connected to the clevis hook 24 as shown in FIG. 2.

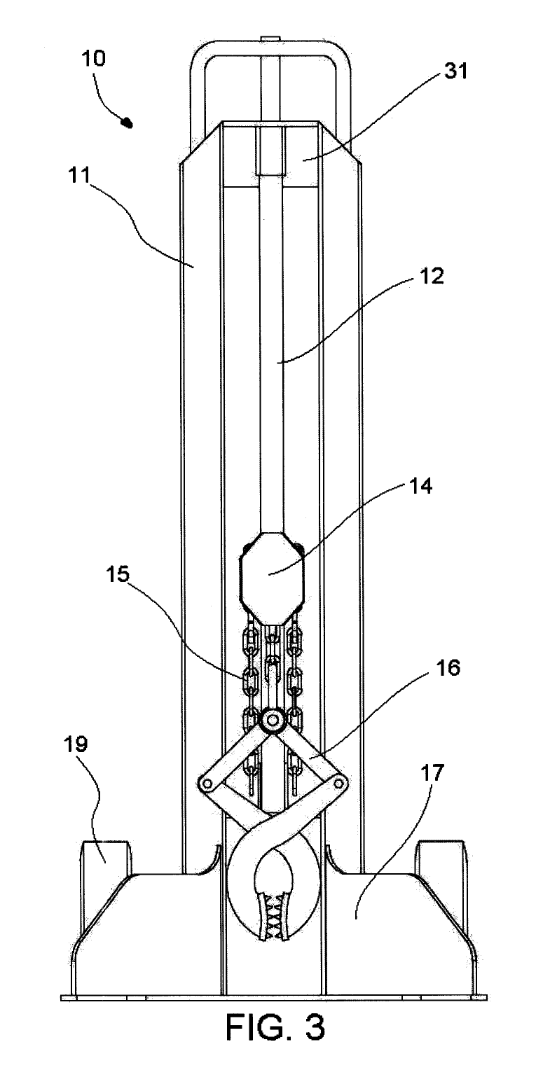

FIG. 3 depicts the jack tower 11 having a pair of parallel columns connected by the tower bridge 31. The device 10 is configured to be wheeled by using a pair of wheels 19, over most terrain and disposed with its tower base footing plate 18 substantially encompassing an area in which the post and a given amount of concrete disposed within the ground. The support plates 17 form a seat or cradle for the post and associated concrete once pulled from the ground so that when the device 10 is tilted for transport, the post and concrete is securely held in place by the jack noze 14 until the same is at a desired position for disposal.

Having illustrated and described the principles of the present invention in a preferred embodiment, it will be apparent to those skilled in the art that the embodiment can be modified in arrangement and detail without departing from such principles. Any and all such embodiments are intended to be included within the scope of the following claims.

What is claimed is:

1. A portable post puller device comprising:
(a) a rollably movable tower base footing plate for supporting the post puller on the ground having a pair of opposing arms, wherein the arms are sufficiently spaced from one another sufficiently to be disposable on about a post and the concrete;
(b) a jack tower having a pair of parallel columns to provide pulling force directly on the axis of the post;
(c) a removable jack removably attached to the jack tower having a vertical jack bar and jack runner;
(d) a post gripper for mechanically pulling the post from the ground through and between the arms;
(e) a releasably attachable jack noze for preventing the post from contacting the vertical shaft after the post is pulled from the ground.
(f) a gripping means for securing the post gripper to the post puller device, wherein the gripping means is adjustable to retain various lengths of the post; and
(g) an upright side plate member extending from the tower base footing plate configured to provide retaining support the concrete piece and the post during transportation after the post is removed from the ground.

2. The portable post puller of claim 1, wherein the tower base footing plate is a generally rigid plate member able adjacent the ground.

3. The portable post puller of claim 1, wherein the jack tower further comprises a spine support plate at a lower end of the jack tower.

4. The portable post puller of claim 1, wherein the jack tower further comprises a tower bridge jack receiver at a top end of the jack tower for preventing the vertical jack bar from being bent by excessive force.

5. The portable post puller of claim 1, wherein the jack tower further comprises a tower lower jack receiver attached to the spine support plate.

6. The portable post puller of claim 5, wherein the tower lower jack receiver further comprises a securing pin.

7. The portable post puller of claim 1, wherein the tower base footing plate further comprises at least a pair of wheels operably connected thereto to enable said device to be readily moved on the wheels.

8. The portable post puller of claim 1, wherein the removable jack further comprises a jack arm to provide a leverage force.

9. The portable post puller device of claim 1, wherein the jack is removably attached to the jack tower by securing the vertical jack bar at the tower lower jack receiver and at the tower bridge jack receiver.

10. The portable post puller device of claim 1, wherein the jack is removable from the jack tower by removing the securing pin at the tower lower jack receiver.

11. The portable post puller device of claim 1, wherein the jack noze further comprises a jack noze securing pin.

12. The portable post puller device of claim 11, wherein the jack noze is removable from the jack runner by removing the jack noze securing pin.

13. The portable post puller device of claim 1, wherein the gripping means further comprises a chain and hook.

14. The portable post puller device of claim 1, wherein the removable jack extends vertically upward from the tower base footing plate.
